(19) United States
(12) Patent Application Publication
(10) Pub. No.: US 2013/0277428 A1
(43) Pub. Date: Oct. 24, 2013

(54) BARCODE AND SCANNING DEVICE AND SCANNING SYSTEM

(71) Applicants: HONG FU JIN PRECISION INDUSTRY (SHENZHE) CO., LTD., Shenzhen (CN); HON HAI PRECISION INDUSTRY CO., LTD., New Taipei (TW)

(72) Inventor: LU-QING MENG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/726,611

(22) Filed: Dec. 26, 2012

(30) Foreign Application Priority Data
Apr. 20, 2012 (CN) 201210117555.5

(51) Int. Cl. G06K 7/10; G06K 19/06

(52) U.S. Cl. CPC G06K 7/1096; G06K 19/06028
USPC 235/440; 235/494

(57) ABSTRACT

A scanning device for scanning a barcode with plurality of bars of different degrees of grayscale includes a processing unit and a plurality of scanning units connected to the processing unit. Each scanning unit includes a light emitting unit and a light sensing unit. When each light emitting unit emits light, each light sensing unit detects reflected light from the barcodes and generates an electrical signal according to the intensity of the reflected light. The processing unit generates a code according to each electrical signal. All the generated codes comprise at least three different codes.

### BACKGROUND

1. Technical Field

The present disclosure relates to a barcode, a scanning device for scanning the barcode, and a scanning system.

2. Description of Related Art

Barcodes provide fast and convenient identification of items, such as goods in supermarkets. A typical barcode includes a series of adjacent black bars and white bars (spaces) with variable widths between them. The barcodes can record binary information, for example, a thick white or black bar represents code “1”, and a thin white or black bar represents code “0”. However, the codes that can be represented by the bars of the barcode are limited.

The scanning device for reading the barcodes includes a light source, a lens, a scanning module, and an analog to digital converter (ADC). When the scanning device scans a barcode, the scanning module receives light reflected by the barcode via the lens; the scanning module converts the reflected light into analog voltages and transmits the analog voltages to the ADC. The ADC converts the analog voltages to digital signals, and a computer connected to the scanning device analyzes the barcode according to the digital signals. However, the lens must be disposed in the scanning device, resulting in a bulky and complex scanning device.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the four views.

FIG. 1 is a schematic diagram of a barcode in accordance with one embodiment.

FIG. 2 is a block diagram showing a scanning device in accordance with one embodiment.

FIG. 3 is a circuit diagram of the scanning device shown in FIG. 2 in accordance with one embodiment.

FIG. 4 is a schematic diagram of the scanning device shown in FIG. 2 scanning the barcode.

### DETAILED DESCRIPTION

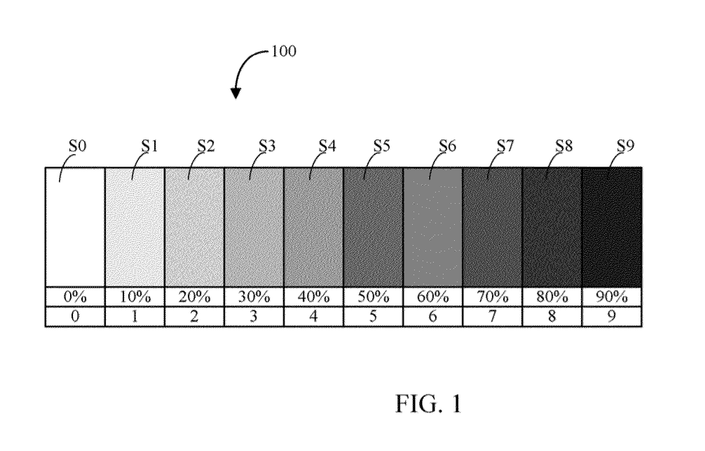

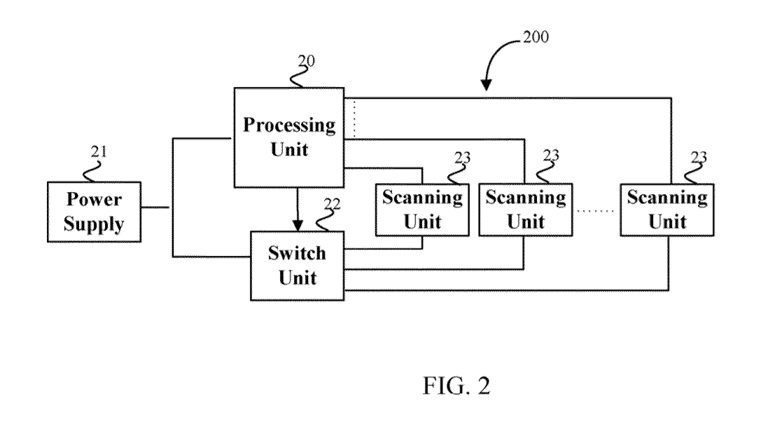

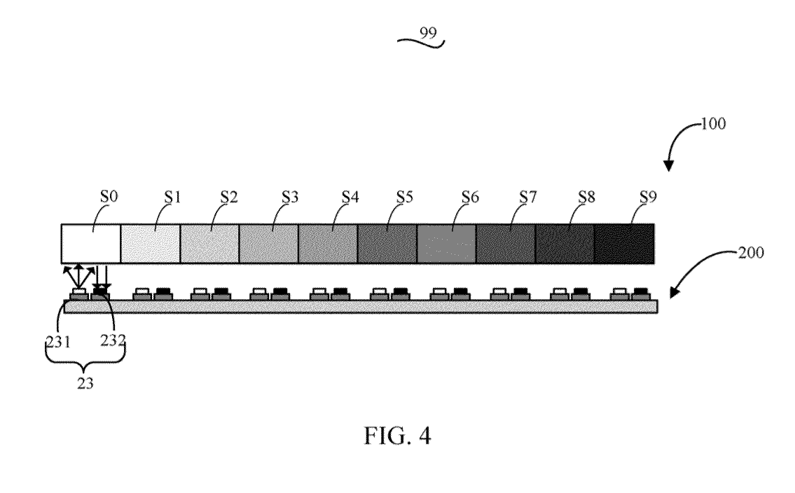

Referring to FIGS. 1 and 2, a scanning system 99 (see in FIG. 4) includes a barcode 100 and a scanning device 200 for scanning the barcode 100. The barcode 100 includes ten bars S0, S1 . . . S9 disposed adjacent to each other. The width of each bar S0, S1 . . . S9 is the same. In this embodiment, the bars S0, S1 . . . S9 have the same basic property, but the values of that basic property of the bars S0, S1 . . . S9 are different in each bar. Each different bar represents a different code.

In the embodiment, the basic property is grayscale. Each of the bars S0, S1 . . . S9 has a different degree of grayscale. The grayscales of the bars S0, S1 . . . S9 are described as follows: the bar S0 is high white; the bar S1 is gray consisting of 10% blackness and 90% whiteness, the bar S2 is gray consisting of 20% blackness and 80% whiteness, the bar S3 is gray consisting of 30% blackness and 70% whiteness, the bar S4 is gray consisting of 40% blackness and 60% whiteness, the bar S5 is gray consisting of 50% blackness and 50% whiteness, the bar S6 is gray consisting of 60% blackness and 40% whiteness, the bar S7 is gray consisting of 70% blackness and 30% whiteness, the bar S8 is gray consisting of 80% blackness and 20% whiteness, the bar S9 is gray consisting of 90% blackness and 10% whiteness. The bars grayscale should be changeable to represent different codes, for example, the bar S0 may represent “9” and the bar S9 may represent “5” (see the next paragraph), they cannot be permanent. In other embodiments, the grayscales of the bars S0, S1 . . . S9 may be changed according to need, for example, high white and deep black, the grayscales of each of the bars S0, S1 . . . S9 also can be changed to polychromatic colors, such as red, or blue, or other color.

In the embodiment, the codes represented by the bars S0, S1 . . . S9 are described as follows: the bar S0 represents number “0”, the bar S1 represents number “1”, the bar S2 represents number “2”, the bar S3 represents number “3”, the bar S4 represents number “4”, the bar S5 represents number “5”, the bar S6 represents number “6”, the bar S7 represents number “7”, the bar S8 represents number “8”, and the bar S9 represents number “9”. In other embodiments, the codes represented by the bars S0, S1 . . . S9 may be changed as needed. The bars S0, S1 . . . S9 can respectively represent the letters “A”, “B”, “C”, “D”, “E”, “F”, “G”, “H”, “I”, “J”.

Referring to FIG. 2, the scanning device 200 includes a processing unit 20, a power supply 21, a switch unit 22 and a plurality of scanning units 23. The power supply 21 is electrically connected to the processing unit 20 and the switch unit 22 for providing a supply voltage. The switch unit 22 is electrically connected to the processing unit 20, and is further electrically connected between the power supply 21 and the scanning units 23. The switch unit 22 allows the supply voltage from the power supply 21 to reach the processing unit 20 and the scanning units 23. The scanning units 23 have a one-to-one relationship with the bars S0, S1 . . . S9. Each scanning unit 23 is electrically connected between the processing unit 20 and the switch unit 22.

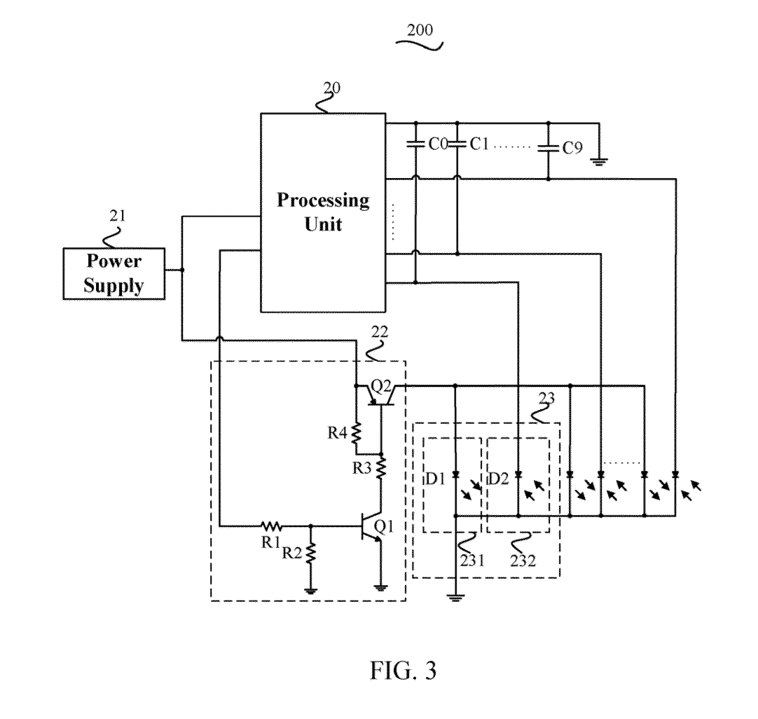

Referring to FIG. 3, the switch unit 22 includes a first transistor Q1, a second transistor Q2, a first resistor R1, a second resistor R2, a third resistor R3 and a fourth resistor R4. A base of the first transistor Q1 is electrically connected to the processing unit 20 via the first resistor R1, a collector of the first transistor Q1 is electrically connected to a base of the second transistor Q2 via the third resistor R3, and an emitter of the first transistor Q1 is grounded. The base of the first transistor Q1 is further grounded via the second resistor R2. The base of the second transistor Q2 is connected to the power supply 21 via the fourth resistor R4, a collector of the second transistor Q2 is connected to the scanning units 23, and an emitter of the second transistor Q2 is connected to the power supply 21. In the embodiment, the first transistor Q1 is a NPN type bipolar junction transistor, and the second transistor Q2 is a PNP type bipolar junction transistor.

Each scanning unit 23 is aligned with a single bar of the bars S0, S1 . . . S9, and includes a light emitting unit 231 and a light sensing unit 232. The width of each scanning unit 23 is not greater than the width of the bars S0, S1 . . . S9. In the embodiment, the light emitting unit 231 includes a light emitting diode D1, and the light sensing unit 232 includes a photodiode D2.

The anode of each light emitting diode D1 is connected to the collector of the transistor Q2, and the cathode of each light emitting diode D1 is grounded. The anode of each photodiode D2 is connected to the processing unit 20, and the cathode of each photodiode D2 is grounded.

The principle of operation of the power manager circuit 10 is illustrated as follows:

Referring to FIG. 4, when the switch unit 22 establishes an electrical connection between the power supply 21 and the scanning units 23 in response to the signal from the processing unit 20, each light emitting unit 231 emits light simultaneously. Each light sensing unit 232 detects light reflected from the bars S0, S1 . . . S9 and generates an electrical signal according to the intensity of the reflected light. The processing unit 20 converts the electrical signal from each light sensing unit 323 into one code. In the embodiment, the codes of the bars S0, S1 . . . S9 respectively represent numbers “0”, “1”, “2”, “3”, “4”, “5”, “6”, “7”, “9”.

Although information and the advantages of the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

1. A scanning device for scanning a barcode, the barcode comprises a plurality of bars having the same basic property; the scanning device comprising:
a processing unit; and
a plurality of scanning units connected to the processing unit and respectively corresponding to the bars; each scanning unit comprising a light emitting unit and a light sensing unit;
wherein at least three bars of the barcode have different values of the basic property to represent at least three bars different codes; each light emitting unit emits light onto the barcode, each light sensing unit detects reflected light from corresponding bar of the barcode and generates an electrical signal according to the intensity of the corresponding reflected light, and the processing unit generates a code according to each electrical signal; and all the generated codes comprise at least three different codes corresponding to the different values.

2. The scanning device as claimed in claim 1, further comprising a power supply and a switching unit, the switching unit is connected between the power supply and the scanning units, and the processing unit is connected to the power supply and the switching unit; the switch unit establishes an electrical connection between the power supply and at least three scanning units in response to a command from the processing unit, and the scanning units simultaneously emit light to the barcode.

3. The scanning device as claimed in claim 2, wherein each light emitting unit comprises a light emitting diode, each light sensing unit comprises a photo diode; an anode of each light emitting diode is connected to the switch unit, a cathode of each light emitting diode is grounded; an anode of each photo diode is connected to the processing unit, a cathode of each photo diode is grounded.

4. The scanning device as claimed in claim 1, wherein the switch unit comprises a first transistor, a second transistor, a first resistor, a second resistor, a third resistor and a fourth resistor; a base of the first transistor is connected to the processing unit via the first resistor, a collector of the first transistor is connected to a base of the second transistor via the third resistor, and an emitter of the first transistor is grounded; the base of the first transistor is further grounded via the second resistor; the base of the second transistor is connected to the power supply via the fourth resistor, a collector of the second transistor is connect to the scanning units, and an emitter of the second transistor is connected to the power supply.

5. The scanning device as claimed in claim 4, wherein the first transistor is a NPN type bipolar junction transistor, and the second transistor is a PNP type bipolar junction transistor.

6. The scanning device as claimed in claim 1, wherein the widths of bars are the same.

7. The scanning device as claimed in claim 1, wherein the width of each scanning unit is smaller than or equal to the width of corresponding bar.

8. The scanning device as claimed in claim 1, wherein the basic property of the barcode is grayscale, all the bars comprise at least three different degree of grayscales corresponding to at least three different codes; when each light emitting unit emits light to the corresponding bar, each light sensing unit detects a reflected light from each bar and generates an electronic signal according to the intensity of the corresponding reflected light, and the processing unit converts the electrical signals to the corresponding code.

9. The scanning device as claimed in claim 8, wherein the degree of grayscales of the bars comprise white, black, and gray, and at least three different codes of the bars are selected from numbers “0”, “1”, “2”, “3”, “4”, “5”, “6”, “7”, “9”.

10. A barcode being scanned by a scanning device, the barcode comprising:
a plurality of bars having the same basic property and capable of reflecting light emitted by the scanning device;
wherein at least three bars of the barcode have different values of the basic property, each bar with different value represents a different code.

11. The barcode as claimed in claim 10, wherein the widths of bars are the same.

12. The barcode as claimed in claim 10, wherein the basic property of the bars is grayscale, the degree of grayscales of the bar comprises white, black, and gray.

13. The barcode as claimed in claim 12, wherein the degree of grayscales of the bars comprise high white, the gray consisting of 50% blackness and 50% whiteness, and deep black.

14. The barcode as claimed in claim 12, wherein the degree of grayscales of the bars comprise white, the gray consisting of 10% black and 90% white, the gray consisting of 20% black and 80% white, the gray consisting of 30% black and 40% white, the gray consisting of 50% blackness and 50% whiteness, the gray consisting of 60% black and 40% white, the gray consisting of 70% black and 30% white, the gray consisting of 80% black and 20% white, the gray consisting of 90% black and 10% white.

15. The barcode as claimed in claim 11, wherein the code represented by the bar is one of the numbers “0”, “1”, “2”, “3”, “4”, “5”, “6”, “7”, “9”.

16. The barcode as claimed in claim 11, wherein the code represented by the bar is one of the letters “A”, “B”, “C”, “D”, “E”, “F”, “G”, “H”, “I”.

17. A scanning system, comprising:
a barcode comprising a plurality of bars having the same basic property; at least three bars of the barcode have different values of the basic property; and
a scanning device for scanning the barcode, the scanning device comprising:
a processing unit; and
a plurality of scanning units connected to the processing unit and respectively corresponding to the bars; each scanning unit comprising a light emitting unit and a light sensing unit;
wherein when each light emitting unit emits light to the barcode, each light sensing unit detects a reflected light from corresponding bar and generates an electrical signal according to the intensity of the corresponding reflected light, the processing unit generates a code according to each electrical signal; and all the generated codes comprise at least three different codes corresponding to the different values.

18. The scanning system as claimed in claim 17, further comprising a power supply and a switching unit, the switching unit is connected between the power supply and the scanning units, and the processing unit is connected to the power supply and the switching unit; the switch unit establishes an electrical connection between the power supply and at least three scanning units in response to a command from the processing unit, and the scanning units simultaneously emit light to the barcode.

19. The scanning system as claimed in claim 17, wherein each light emitting unit comprises a light emitting diode, each light sensing unit comprises a photo diode; an anode of each light emitting diode is connected to the switch unit, a cathode of each light emitting diode is grounded; an anode of each light emitting diode is connected to the processing unit, a cathode of each photo diode is grounded.

20. The scanning device as claimed in claim 18, wherein the switch unit comprises a first transistor, a second transistor, a first resistor, a second resistor, a third resistor and a fourth resistor; a base of the first transistor is connected to the processing unit via the first resistor, a collector of the first transistor is connected to a base of the second transistor via the third resistor, and an emitter of the first transistor is grounded; the base of the first transistor is further grounded via the second resistor; the base of the second transistor is connected to the power supply via the fourth resistor, a collector of the second transistor is connect to the scanning units, and an emitter of the second transistor is connected to the power supply.
